(19) United States
(12) Patent Application Publication
(10) Pub. No.: US 2003/0053536 A1
(43) Pub. Date: Mar. 20, 2003

(54) System and method for acquiring and transmitting environmental information

(76) Inventor: Stephanie Ebrami, Beverly Hills, CA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/956,569

(22) Filed: Sep. 18, 2001

(51) Int. Cl. H04N 7/12; H04N 7/18

(52) U.S. Cl. 375/240.01; 348/148; 375/240.25; 348/143

(57) ABSTRACT

A system and a method for acquiring and transmitting environmental information recorded around a vehicle comprising of including at least one camera. The output from the camera is encoded and stored in a storage device. The encoded signal is also transmitted wirelessly to a remote location or a server for subsequent analysis. The stored signal may also be decoded and displayed on a video display unit.

### BACKGROUND OF THE INVENTION

1. Field of the Invention

The present invention relates to security devices and systems for monitoring people, objects, environment, and/or valuable equipment.

Especially, the present invention relates to a monitoring system for recording the state of a vehicle/person/environment, and transmitting this recorded information to a remote location in an efficient manner.

2. General Background

In recent years, the incidence of equipment theft, such as electronic goods and vehicles, has increased dramatically. For example, in recent years, it is not uncommon to find numerous automotive vehicles where the sales cost easily exceeds $50.000.00 to $100.000.00. As a result, there has been an increasingly available black market for stolen automotive vehicle, which may be either resold or otherwise stripped for parts.

In addition to the increase in theft, there has also been a substantial increase in the amount of vandalism to automotive vehicles. While the precise cause of the vandalism are relatively uncertain, the fact remains that there has been a substantial increase of vandalism associated with many vehicle/person/environment giving rise in increased number of insurance clams and higher insurance premium costs.

Furthermore, with more people driving automobiles, motorcycles, boats or other vehicles the incidence of accidents are on the rise. In many instances, eyewitness accounts in accidents can be substantially unreliable, thereby leading to high-cost litigation for the person(s) involved in the accident.

The latest technique used in automotive vehicle theft has been the terrifying force of car-jacking. Car-jackers are forcing the owner or user of the automotive vehicle to give up possession thereof, usually by means of a weapon of some kind. Sometimes, criminals may also resort to violent tactics to perform a car-jacking operation, thereby leading to loss of lives.

### SUMMARY OF THE INVENTION

Clearly there is a need for monitoring valuable equipment, such as electronic goods and vehicles, on a continuous basis. Furthermore, this surveillance information should be readily accessible to authorized personnel, either locally or remotely, as and when necessary.

Accordingly, in one embodiment of the present invention, the system for acquiring and transmitting environmental information comprises: (i) at least one video/image capturing device such as a camera, (ii) at least one analog to digital converter, (iii) at least one multiplexer for routing the surveillance signal from the at least one camera at an input to an output, (iv) at least one system providing a compression and an uncompression algorithm, such as an MPEG encoder/decoder, (v) a continuously updated storage device, and (vi) a wireless mobile communications system.

Accordingly, in another embodiment of the present invention, the system for acquiring and transmitting environmental information comprises: (i) at least one video/image capturing device such as a camera, (ii) at least one vibration/motion sensor and/or a manual push button, and/or a remote control operating means, and/or a microphone for activating and deactivating the image capturing mechanism, (iii) at least one analog to digital converter, (iv) at least one multiplexer for routing the surveillance signal from the at least one camera at an input to an output, (v) at least one system providing a compression and an uncompression algorithm, such as an MPEG encoder/decoder, (vi) a continuously updated storage device, and (vii) a wireless mobile communications system.

### BRIEF DESCRIPTION OF THE DRAWINGS

In order that the manner in which the above-recited advantages and objects of the invention are attained, as well as others which will become apparent, more particular description of the invention briefly summarized above may be had by reference to the specific embodiments thereof that are illustrated in the appended drawings. It is to be understood, however, that the appended drawings illustrate only typical embodiments of the invention and are therefore not to be considered limiting of its scope, for the invention may admit to other equally effective embodiments.

In the drawings:

FIG. 1 depicts a side view of one embodiment in the present system, the system being incorporated at the top of an automobile;

FIG. 2 shows an exemplary backup power supply for the system according to the present invention;

FIG. 3 shows a zoomed side view of the embodiment depicted in FIG. 1;

FIG. 4 shows a top view of the present invention comprising a rotatable camera, the camera being mounted on top of an automobile as depicted in FIG. 1;

FIG. 5 shows a top view of another embodiment in the present invention depicting a plurality of cameras for capturing a plurality of images;

FIG. 6 shows another embodiment in the present system, the system being incorporated inside an automobile;

FIG. 7 is a system level diagram depicting one embodiment of the present invention depicting a single camera;

FIG. 8 is a system level diagram depicting another embodiment of the present invention depicting a plurality of cameras;

FIG. 9 is a system level diagram depicting another embodiment of the present invention depicting a plurality of cameras and a recorder for recording vehicle mechanical functions; and

FIG. 10 is a system level diagram depicting another embodiment of the present invention depicting a plurality of cameras.

### DETAILED DESCRIPTION OF PREFERRED EMBODIMENTS OF THE INVENTION

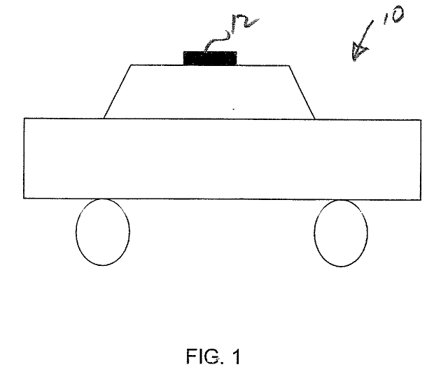

Referring now in detail and by reference characters to the drawings, which illustrate several different embodiments of the present invention. Numeral 10, in FIG. 1, designates an automotive vehicle, which is equipped with the environmental recording system 12 of the present invention. In this case, the invention is illustrated as being employed in connection with an automobile. However, the environmental recording system can be used with essentially any type of vehicle, including, for example, boats, trucks, airplane, motorhomes, etc. It is also foreseeable to incorporate the present environmental recorder in watches, necklaces or other wearable or attachable devices on persons, pets, or objects using micro-electro-mechanical-systems (MEMS). These devices do not necessarily have to be attached to the person, vehicle, pet or other object, so long as they are near enough in proximity to provide the environmental information necessary.

The environmental recording system, according to the present invention, comprises one or more video cameras positioned in the environmental recording system 12. These cameras are operatively mounted on the vehicle body, an individual or an object. As shown in FIG. 1, the camera mount is positioned on the roof of the automobile. Alternatively the cameras can be “embedded” in the front hood and in the rear trunk for recording front/front-side and rear/rear-side information.

In a preferred mode, and in order to prevent theft, vandalism, or accidental damage of the camera or cameras in 12, it is preferable to mount the cameras within the interior of the vehicle so that the vehicle can be locked and thereby essentially preclude damage or theft of the camera or cameras. In any event, the system according to the present invention can record and transmit information related to a theft or accident to a remote location.

The camera(s) positioned in the system depicted as 12 are essentially conventional in construction and generally comprise one or more known video cameras which are usually operable either from a portable battery source of power or from electrical outlets, such as a 110 volt household current electrical outlet. The battery can be made portable so that it may be positioned directly on an individual. In a preferred embodiment of the invention, the cameras in 12 are operable from the electrical power system of the automotive vehicle. For this purpose, the cameras in 12 are connected to the vehicle's electrical circuitry through a conventional circuitry.

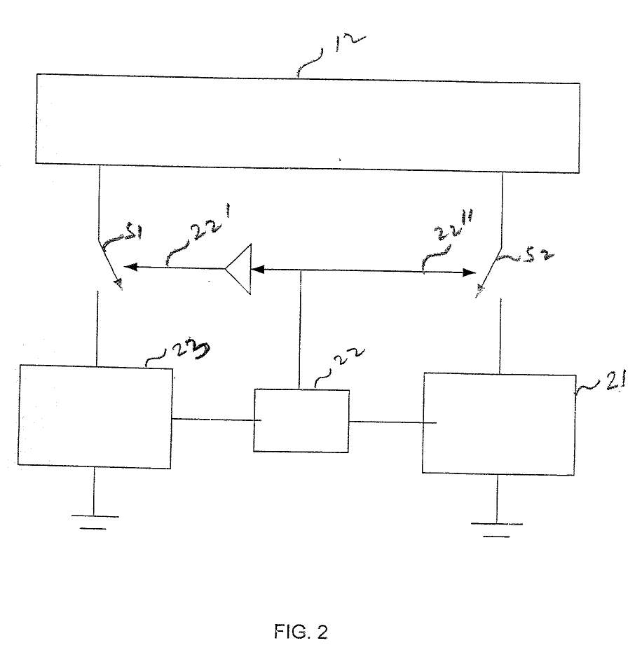

In one aspect, the environmental recording system may employ a rechargeable primary power source (for example, when used on an object or a person). Alternatively, a backup portable power supply is powered on in case of battery failure. An exemplary view of such a portable backup source is shown in FIG. 2. Upon detecting the absence of a supply, such as a voltage or a current, the detector 22 activates the backup power supply 23 to the environmental recording system 12. The output of the detector 22 comprises two complementary signals that are applied to the switches S1 and S2. Thus, for example, in case the vehicle battery 21 fails, a level high along 22′ closes switch S1, while a level low along 22″ opens switch S2.

It may be possible that the vehicle be left at an unattended spot for a period of time. This may cause the vehicle battery to run out. Accordingly, the invention also envisions a battery level monitor that monitors the state of a battery of a vehicle. If the battery level of a vehicle falls below a certain threshold, a monitoring device will automatically switch the power source to the backup battery. Upon starting the vehicle, the vehicle battery may operate in a manner so as to charge the backup battery appropriately. The backup battery may also be portable so as to be carried on an object or on a person.

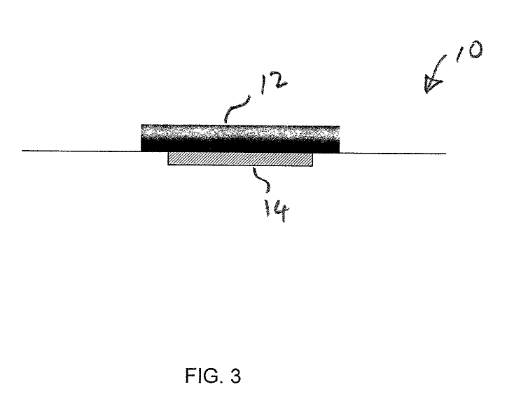

A zoomed side view of the environmental recording system 12 is shown in FIG. 3. The system 12 is fixedly mounted on a base or attachment 14 to prevent translational motion of the system 12. Attachment 14 thereby allows the camera(s) to accurately capture the surrounding environmental information along predetermined angles.

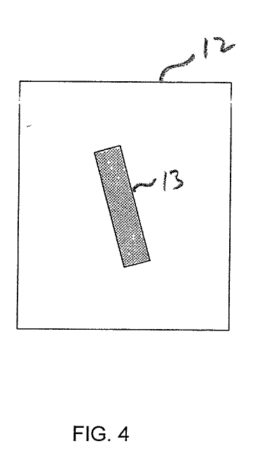

FIG. 4 depicts a top view of the environmental recording system 12. As shown, a single rotatable camera 13 rotating at a predetermined angular velocity can be used to sample environmental information along 360 degrees in the vicinity of the automobile 10. The camera may also be manually tilted about a horizontal axis so as to capture any desired surrounding information at arbitrary elevation angles. Alternatively, an algorithm may automatically control the tilt of the camera at preset times.

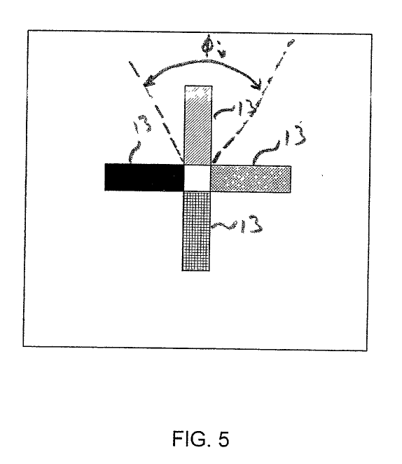

As an alternative, multiple cameras may be used to capture the surrounding environmental information. This embodiment is shown in FIG. 5. As generally shown in FIG. 5, each of the four cameras, labeled generally as 13, in 12 may be used to capture surrounding information at predetermined azimuth angles φᵢ(i=1,2,3,4). For example, φᵢ>=90 degrees for each camera so as to cover the full 360 degrees arc around the vehicle. As mentioned earlier, the cameras may be either manually or automatically tilted about a horizontal axis so as to capture any desired surrounding information at arbitrary elevation angles.

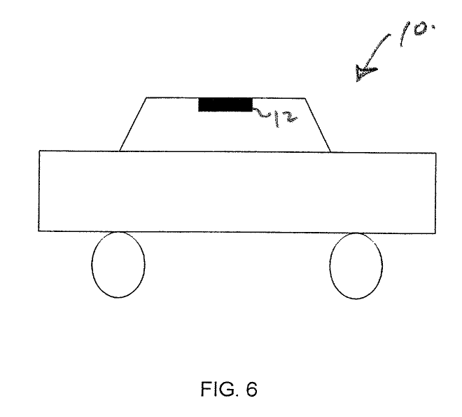

As stated earlier, in a preferred embodiment, and in order to prevent theft, vandalism, or accidental damage of the camera or cameras in 12, it is preferable to mount the cameras within the interior of the vehicle so that the vehicle can be locked and thereby essentially preclude damage or theft of the camera or cameras. This secured embodiment is depicted in FIG. 6.

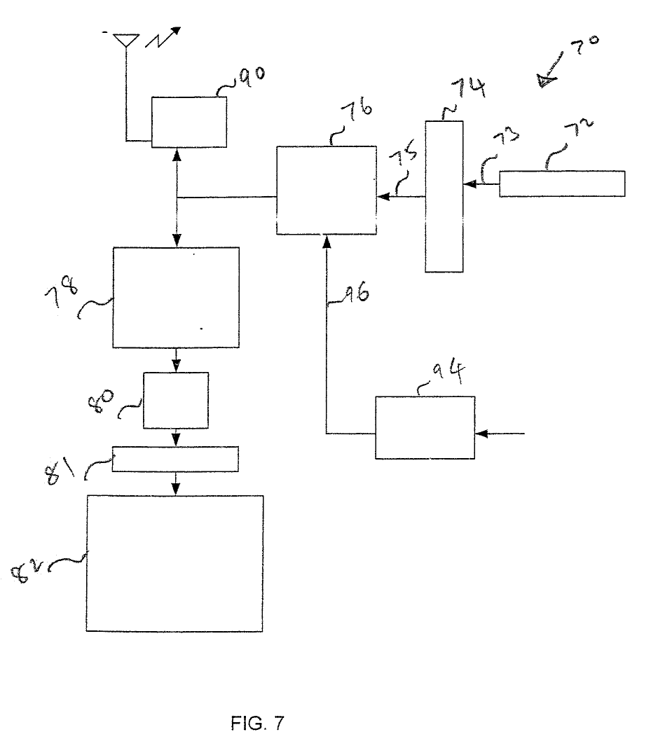

The system level block diagram 70 depicting one embodiment of the present invention is shown in FIG. 7. As an example, only one camera 72 is shown. The output from the camera is typically an analog video signal 73. By including an analog to digital converter 74, a digital signal 75 may be supplied to an encoder 76, such as an MPEG encoder. The MPEG encoding scheme has been widely accepted for encoding high quality video for efficient storage, transmission and broadcasting purposes. By incorporating such an encoder, the system according to the present invention compresses and encodes the video signal for subsequent rapid storage transmission.

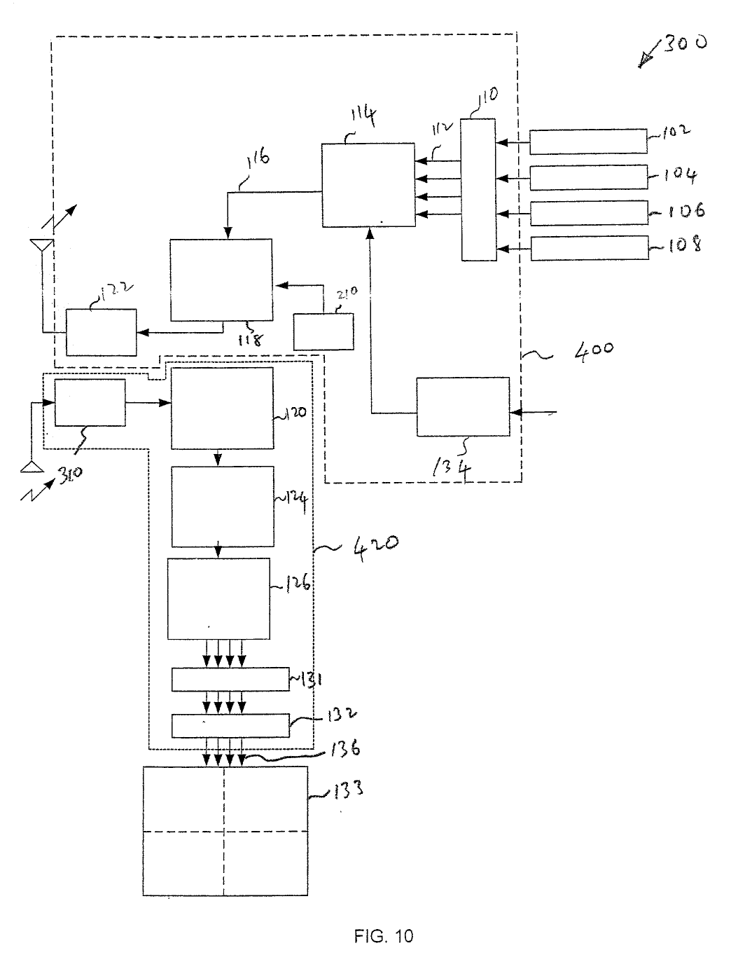

The output from the encoder 76 is supplied to a storage device 78. Thus, the video signal from the surrounding environment can be recorded and stored for an arbitrary period of time (for e.g., fifteen minutes) in the storage device 78. The storage device may be remote, or may be in a vehicle, on an object, or on a person. In the present depiction, the storage device is shown as belonging to be in the vehicle (the remote version is depicted in FIG. 10, and will be explained subsequently). The storage device operates preferably in a first in first out mode. The storage device finds use for extracting information from the environment in case of a vehicle theft or an accident. This functionality of the storage device is akin to the functionality of the black box recorder found in airplanes.

The first recorded signal in the storage device is supplied first to a decoder, such as an MPEG decoder 80, for decompressing and decoding the video signals. The output from decoder 80 is substantially similar to the digitized video signal 75. This digitized signal may be supplied to a monitor 82, or may be converted back into an analog signal through a digital-analog converter 81 for display.

Also present in the environmental recording system 12 is a transmitting device 90. Device 90 may include a typical wireless communication system having a modulator and a transmitting antenna, as is well known in the art. The encoded video signal is transmitted to a remote location for subsequent analysis. For example, the video signal may be sent over the Internet to a remote web server that is accessible by the general community. The web server may be password protected to prevent unwanted tampering. Registered owners of the vehicles and/or police may use this site to monitor the surrounding vicinity of the vehicle in the event of theft, accident, or any other similar events. It may also be possible to transmit the video signal to a remote server located at an insurance company website in the event of an accident. The images may also be transmitted to an individual's personal/portable device such as a palm pilot.

The environmental recording system 12 may also include a system 94 for controlling the start and stop time for recording the surrounding environment. This control may be achieved manually or via a voice activation device. Alternatively, this control may also be achieved through a vibration/shock/motion sensor in the event of an accident (for example, the vibration sensor may send a deactivation signal 96 to the multiplexer to terminate sampling the video signal from the camera, in the event that the sensor detects a force greater than a preset amount due to an impact in an accident).

As an additional aspect, the environmental recording system may comprise one or more cameras for transmitting and recording image data, and multiple microphones for transmitting and recording audio signals. The image signals and the audio signals may be multiplexed separately or together. These image and audio signals may also be stored separately or on a single storage device, and may be encoded/decoded by a single system or multiple systems. A display device and a conventional audio speaker may then be used to recreate the decoded image and audio signals at a user terminal.

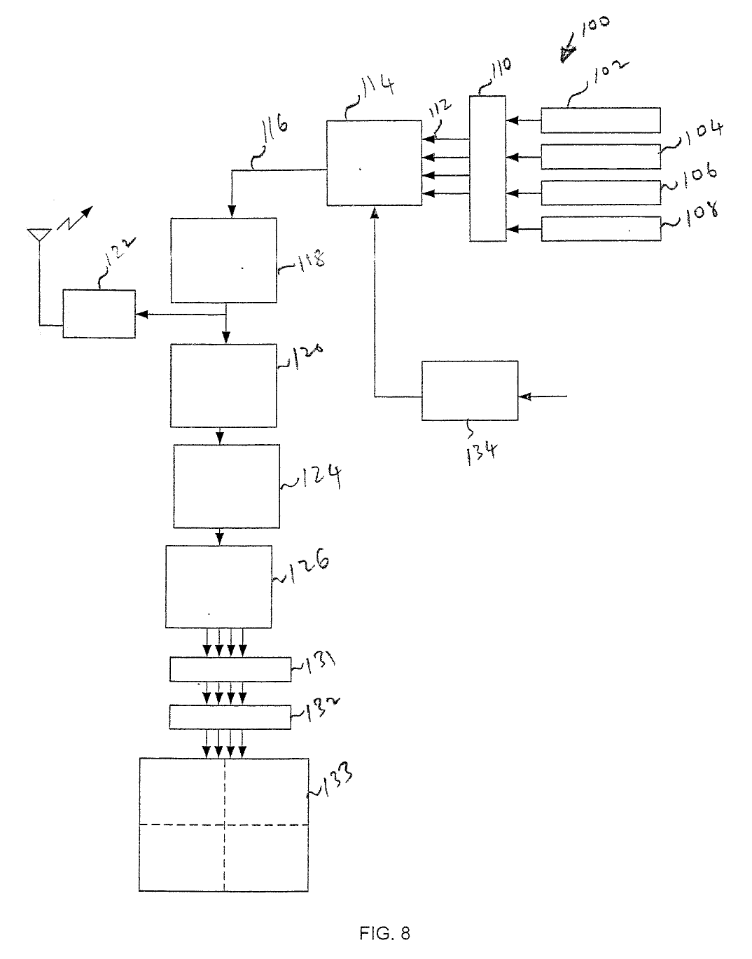

In another embodiment of the present invention, the environmental recording system 12, may include a plurality of cameras. The block diagram for such a system is shown in FIG. 8 and is denoted by numeral 100. As generally shown in an exemplary embodiment, four cameras 102, 104, 106, and 108 record a full 360 degrees of an arc surrounding the vehicle. A bank of analog-digital converters 110 converts the analog video signals into a digital signal 112. This digital signal 112 is supplied to a multiplexer 114 that may sample the digital signals in a sequential mode thereby yielding a multiplexed output signal 116. Output signal 116 is supplied to an encoder 118, such as an MPEG encoder for compression and encoding for subsequent rapid storage and transmission.

The output from the encoder 118 is supplied to a first in first out storage device 120 which may be positioned in a vehicle or on a person (an alternative embodiment wherein the storage device is located at a remote location will be described in FIG. 10), whose general description is mentioned above. The output from the encoder 118 is also transmitted via a wireless communications device 122, as generally explained above, to a remote location or a remote server.

The first recorded signal in the storage device is supplied first to a decoder, such as an MPEG decoder 124, for decompressing and decoding the video signals. The output from decoder 124 is substantially similar the digitized and multiplexed video signal 116. This multiplexed signal is then supplied to a demultiplexer 126 for extracting the digital signals corresponding to each camera.

The demultiplexed signals may be converted back into analog format through a digital-analog converter 131 for subsequent display. The output signals from the digital-analog converter 131 are then sent to a video display device 133. Alternatively, the output from the digital-analog converter 131 may be supplied to a formatter 132 for displaying each of the camera images at predetermined positions on video display device 133.

The environmental recording system 12 may also include a system 134 for controlling the start and stop time for recording the surrounding environment. This control may be achieved manually or via a voice activation device. Alternatively, this control may also be achieved through a vibration sensor in the event of an accident (for example, the vibration sensor may send a deactivation signal 96 to the multiplexer to terminate sampling the video signal from the camera, in the event that the sensor detects a force greater than a preset amount due to an impact in an accident).

In an alternative embodiment, the devices including the encoder, the wireless transmitter device, the storage device, multiplexer, receiver, demultiplexer, the decoder; or any combinations thereof may be located on a single semiconductor chip. Such a chip may be reconfigurable and may have compression algorithms on it, and it may further interface with Bluetooth based devices. It may also have an MPEG encoding/decoding algorithm, and may transmit data wirelessly using CDMA/GSM standards.

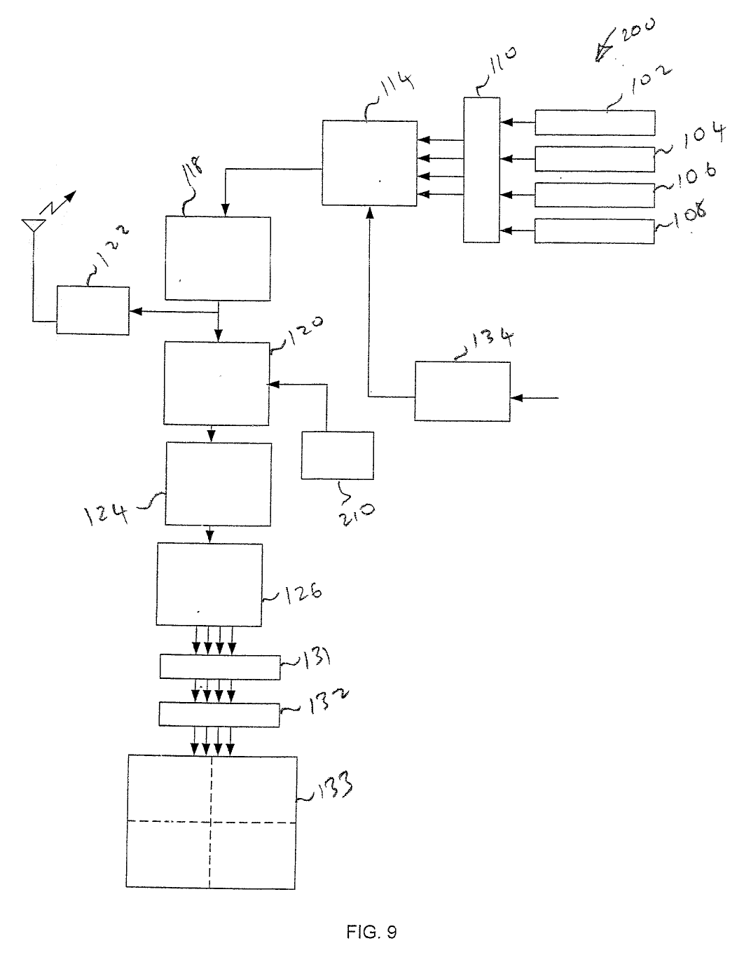

As shown in FIG. 9, the environmental recording system 200 may additionally include a vehicle parameter monitoring system 210 for recording the speed of a vehicle, the impact force in an accident, engine revolution, transmission gear parameters, events occurring inside vehicles, and other such vehicle critical parameters such as mechanical functions. For example, such parameters may be subsequently used by police and/or insurance companies for determining fault in the event of an accident.

As shown in FIG. 10, the storage device, the decoder, and demultiplexer of the environmental recording system 300 may be located at a remote site or server. For this purpose a receiver 310 is employed for demodulating the received wireless transmission. A vehicle parameter monitoring system 210 for recording the speed of a vehicle, the impact force in an accident, and other such vehicle critical parameters may be included in the environmental recording system 300. The receiver transmits the encoded digital data, comprising the multiplexed image signals (and possibly audio signals from microphones), and the vehicle/object parameters onto a storage device 120 located at the server, such as an Internet server. Upon user request, the data from the storage device is retrieved and supplied to a decoder 124 for a decoding operation. The decoded signal is then applied to a demultiplexer 126. The demultiplexed signals from the output of the demultiplexer 126 are supplied to (digital-analog) D/A converter 131, if necessary, to convert to analog form. The output from the D/A converter is then applied to a formatter 132 for properly displaying the signals on a display device. The formatted signals 136 are then transmitted to the user terminal display device 133 (such as to a Palm Pilot or a monitor) either wirelessly or via a regular Internet connection (i.e., a landline).

An alternative embodiment depicting the incorporation of the environmental recording system in semiconductor chip(s) is also shown in FIG. 10. Semiconductor chip 400 includes the encoder 118, multiplexer 114, the transmitter 122, the vehicle parameter monitoring system 210, system 134 for controlling the start and stop time for recording the surrounding environment, and/or the A/D converter 110, or any combinations thereof. Semiconductor chip 420 includes the storage device 120, the decoder 124, the receiver 310, the demultiplexer 126, and/or the D/A converter 131 (and possibly the formatter 132), or any combinations thereof. Furthermore, semiconductor chips 400 and 420 may be reconfigurable.

While the specification describes particular embodiments of the present invention, those of ordinary skill can devise variations of the present invention without departing from the inventive concept. Further applications include in vehicles, on objects, or on individuals. For example, a miniaturized version of the present system can be implemented on a wristwatch or a child's necklace, or on a nursing home resident, or on similar application systems, by incorporating the multiplexer, encoder, storage device, demultiplexer, and the wireless transmitter in a MEMS device. Alternatively, the encoder, decoder, and the wireless transmitter may be embedded in a single chip. Furthermore, in the event a digital camera system is used, the analog-digital and digital-analog converters may be dispensed with. In addition, the primary and/or backup power source could be a solar battery.

I claim the following:

1. An environmental recording system for monitoring and transmitting a state of a vehicle to a remote, location, the system comprising:
a camera to monitor a state of a vehicle;
an encoder to compress an image signal delivered by the camera;
a storage device for recording the compressed image from an output of the encoder; and
a transmitter for transmitting the compressed image from the output of the encoder to a remote location.

2. The environmental recording system according to claim 1, wherein the surveillance system further comprises at least one additional camera to monitor the state of a vehicle, said at least one additional camera monitoring the state of a vehicle in a direction substantially different than the direction of monitoring by the other camera.

3. The environmental recording system according to claim 2, wherein the surveillance system further comprises a multiplexer for combining the image signal delivered by the camera with an additional image signal delivered by the additional camera.

4. The environmental recording system according to claim 1, wherein the surveillance system further comprises a decoder, said decoder delivering a decompressed image at an output of the decoder.

5. The environmental recording system according to claim 4, wherein the surveillance system further comprises at least one monitor to display the decompressed image at the output of the decoder.

6. The environmental recording system according to claim 4, wherein the decoder is an MPEG decoder.

7. The environmental recording system according to claim 1, wherein the encoder is an MPEG encoder.

8. The environmental recording system according to claim 1, wherein the surveillance system further comprises at least one motion sensor.

9. The environmental recording system according to claim 1, wherein the surveillance system further comprises an ignition sensor.

10. The environmental recording system according to claim 1, wherein the surveillance system further comprises a video display.

11. The environmental recording system according to claim 1, wherein the storage device operates in a first in-first out mode.

12. The environmental recording system according to claim 1, further comprising a battery level monitor.

13. A method for monitoring and transmitting a state of a vehicle to a remote location, the method comprising the steps of:
sampling a video signal from at least one camera output;
multiplexing the video signal from the at least one camera output to form a first signal;
encoding the first signal to form a second signal;
storing the second signal in a storage device; and
transmitting the second signal through a communications transmitter.

14. The method according to claim 13, further comprising the step of decoding the second signal to form a third signal.

15. The method according to claim 13, wherein the multiplexing is performed, additionally, on an output from an additional camera

16. The method according to claim 14, wherein said step of decoding is performed by an MPEG decoder.

17. The method according to claim 13, wherein said step of encoding is performed by an MPEG encoder.

18. The method according to claim 13, wherein the storage device operates in a first in-first out mode.

19. The method according to claim 14, further comprising the step of demultiplexing the third signal to form a plurality of video signals.

20. The method according to claim 19, further comprising the step of formatting the plurality of video signals to display on a display device.

21. The method according to claim 20, further comprising the step of displaying the video signals on a display device.

22. The method according to claim 21, wherein the communications transmitters is a wireless transmitter.

23. A method for monitoring and transmitting a state of a vehicle to a remote location, the method comprising the steps of:
acquiring a plurality of video signals from a plurality of cameras;
multiplexing the video signals from the camera outputs to form a first signal;
encoding the first signal to form a second signal;
storing the second signal in a storage device;
transmitting the second signal through a communications transmitter;
decoding the second signal to obtain a third signal; said third signal being substantially similar to the first signal; and
demultiplexing the third signal to yield a demultiplexed plurality of video signals.

24. The method according to claim 23, further comprising the step of formatting the demultiplexed plurality of video signals onto a video display unit.

25. The method according to claim 23, further comprising the step of activating or deactivating the acquisition of the video signals.

26. The method according to claim 23, further comprising the step of converting the acquired plurality of video signals into a plurality of digital video signals.

27. The method according to claim 23, further comprising the step of converting the demultiplexed video signals into a plurality of analog video signals.

28. The method according to claim 23, wherein the remote location is a police station.

29. The method according to claim 23, wherein the steps of encoding, transmitting, and decoding are performed on a single microprocessor chip.

30. The method according to claim 29, wherein the steps of multiplexing, demultiplexing, and storing are performed on said single microprocessor chip.

31. The method according to claim 30, wherein the communications transmitters is a wireless transmitter.

32. A method for providing video signals on a web site server to a customer, the method comprising the steps of:
acquiring at least one video signal from at least one video camera;
encoding the at least one video signal by a first encoder;
transmitting the at least one video signal by a wireless communication system to a web site server;
storing the transmitted signal on a storage device at the server;
providing access to a customer to the server;
decoding the stored signal upon request from the customer; and
displaying the decoded signal on a display device of the customer.

33. The method according to claim 32, further comprising the steps of:
acquiring at least one audio signal from at least one microphone;
encoding the at least one audio signal;
transmitting the at least one audio signal by the wireless communication system to the web site server;
storing the transmitted audio signal on the storage device at the server;
providing access to the customer to the server;
decoding the stored audio signal upon request from the customer; and
rendering the decoded audio signal on a loudspeaker of the customer.

34. An environmental recording system comprising:
a first semiconductor device having a multiplexer for multiplexing a plurality of image signals, said first semiconductor chip further having (i) an encoder for encoding the plurality of image signals, (ii) a wireless transmitter for transmitting the encoded plurality of image signals; and
a second semiconductor device having (i) a receiver for receiving the transmitted plurality of image signals, (ii) a storage device for storing the received plurality of image signals, (iii) a decoder for decoding the stored plurality of image signals.

35. The environmental recording system according to claim 34, further comprising a demultiplexer, located in the second semiconductor device, for demultiplexing the decoded plurality of image signals.

36. The environmental recording system according to claim 35, further comprising a formatter, located in the second semiconductor device, for formatting the image signals on a display device.

37. The environmental recording system according to claim 34, wherein the first semiconductor device has an analog to digital converter.

38. The environmental recording system according to claim 34, wherein the second semiconductor device has a digital to analog converter.

39. An environmental recording system for monitoring and transmitting a state of an object, living or inanimate, to a remote location, the system comprising:
a camera to monitor a state of the object;
an encoder to compress an image signal delivered by the camera;
a storage device for recording the compressed image from an output of the encoder; and
a transmitter for transmitting the compressed image from the output of the encoder to a remote location.

40. The environmental recording system according to claim 39, wherein the surveillance system further comprises at least one additional camera to monitor the state of the object, said additional camera monitoring the state of the object in a direction substantially different than a direction of monitoring of the camera.

41. The environmental recording system according to claim 40, wherein the surveillance system further comprises a multiplexer for combining the image signal delivered by the camera with an additional image signal delivered by the additional camera.

42. The environmental recording system according to claim 37, wherein the surveillance system further comprises a decoder, said decoder delivering a decompressed image at an output of the decoder.

43. The environmental recording system according to claim 42, wherein the surveillance system further comprises at least one monitor to display the decompressed image at the output of the decoder.

44. The environmental recording system according to claim 42, wherein the decoder is an MPEG decoder.

45. The environmental recording system according to claim 39, wherein the encoder is an MPEG encoder.

46. The environmental recording system according to claim 39, wherein the surveillance system further comprises at least one motion sensor.

47. The environmental recording system according to claim 39, wherein the surveillance system further comprises an ignition sensor.

48. The environmental recording system according to claim 39, wherein the surveillance system further comprises a video display.

49. The environmental recording system according to claim 39, wherein the storage device operates in a first in-first out mode.

50. The environmental recording system according to claim 39, further comprising a battery level monitor.

51. The method according to claim 50, wherein the communications transmitters is a wireless transmitter.

52. A method for monitoring and transmitting a state of an object, living or inanimate, to a remote location, the method comprising the steps of:
sampling a video signal from at least one camera output;
multiplexing the video signal from the at least one camera output to form a first signal;
encoding the first signal to form a second signal;
storing the second signal in a storage device; and
transmitting the second signal through a communications transmitter.

53. The method according to claim 52, further comprising the step of decoding the second signal to form a third signal.

54. The method according to claim 52, wherein the multiplexing is performed, additionally, on an output from an additional camera

55. The method according to claim 53, wherein said step of decoding is performed by an MPEG decoder.

56. The method according to claim 52, wherein said step of encoding is performed by an MPEG encoder.

57. The method according to claim 52, wherein the storage device operates in a first in-first out mode.

58. The method according to claim 53, further comprising the step of demultiplexing the third signal to form a plurality of video signals.

59. The method according to claim 58, further comprising the step of formatting the plurality of video signals to display on a display device.

60. The method according to claim 59, further comprising the step of displaying the video signals on a display device.

61. A method for monitoring and transmitting a state of an object, living or inanimate, to a remote location, the method comprising the steps of:
acquiring a plurality of video signals from a plurality of cameras;
multiplexing the video signals from the camera outputs to form a first signal;
encoding the first signal to form a second signal;
storing the second signal in a storage device;
transmitting the second signal through a communications transmitter;
decoding the second signal to obtain a third signal; said third signal being substantially similar to the first signal; and
demultiplexing the third signal to yield a demultiplexed plurality of video signals.

62. The method according to claim 61, further comprising the step of formatting the demultiplexed plurality of video signals onto a video display unit.

63. The method according to claim 61, further comprising the step of activating or deactivating the acquisition of the video signals.

64. The method according to claim 61, further comprising the step of converting the acquired plurality of video signals into a plurality of digital video signals.

65. The method according to claim 61, further comprising the step of converting the demultiplexed video signals into a plurality of analog video signals.

66. The method according to claim 61, wherein the remote location is a police station.

67. The method according to claim 61, wherein the steps of encoding, transmitting, and decoding are performed on a single microprocessor chip.

68. The method according to claim 61, wherein the steps of multiplexing, demultiplexing, and storing are performed on said single microprocessor chip.

69. The method according to claim 61, wherein the communications transmitters is a wireless transmitter.
